(19) United States
(12) Patent Application Publication
(10) Pub. No.: US 2026/0086844 A1
(43) Pub. Date: Mar. 26, 2026

(54) CONTEXT SWITCHING

(71) Applicant: Arm Limited, Cambridge (GB)

(72) Inventor: Alex Beharrell, Cambridge (GB)

(73) Assignee: Arm Limited, Cambridge (GB)

(21) Appl. No.: 19/314,372

(22) Filed: Aug. 29, 2025

(30) Foreign Application Priority Data
Sep. 20, 2024 (GB) 2413893.5

(51) Int. Cl. G06F 9/46; G06F 9/30; G06F 11/07; G06F 13/38

(52) U.S. Cl. CPC G06F 9/461; G06F 9/30123; G06F 11/079; G06F 13/382

(57) ABSTRACT

Methods of context switching, and corresponding computer programs, storage media, and apparatuses are disclosed. Data processing operations are performed in a first context and a routine is called which is to be executed in a second context. Initially the routine executes in the first context. Then memory region definitions other than those required for execution of the routine are disabled. A temporary switch is made to a set of all-cacheable memory access attributes. Then memory region definitions required for execution of the routine are copied into one or more spare elements of a memory region definitions register. An atomic switch of execution of the routine to a temporary context using a temporary memory map is carried out, by enabling the copy of the one or more memory region definitions required for execution of the routine and disabling the original versions. Then a second memory map is set up by storing a second set of memory region definitions in one or more predetermined elements of the memory region definitions register. Finally another atomic switch is carried out, switching execution of the routine to the second context using the second memory map by enabling new second set of memory region definitions and disabling the temporary copies of the memory region definitions.

The present techniques relate to the operation of a data processing apparatus. In particular it relates to context switching in a data processing apparatus.

At least some examples provide a method of operating a data processing apparatus comprising:
performing data processing operations comprising accesses to memory, wherein the accesses to memory are delimited by a memory map defined by a set of memory region definitions held in elements of a memory region definitions register, and wherein the accesses are controlled by a set of access attributes associated with the set of memory region definitions;
performing first data processing operations in a first context, wherein the first context uses a first memory map defined by a first set of memory region definitions held in the elements of the memory region definitions register, and wherein the accesses to the memory are controlled by a first set of access attributes; and
during the first data processing operations calling a routine and initiating a transition to execution of the routine in a second context, wherein the second context uses a second memory map defined by a second set of memory region definitions held in the elements of the memory region definitions register, wherein the transition to execution of the routine comprises steps of:
initially executing the routine in the first context;
the routine disabling memory region definitions in the first set of memory region definitions held in the elements of the memory region definitions register other than at least one excepted definition, wherein the at least one excepted definition comprises one or more memory region definitions required for execution of the routine;
the routine switching from the first set of access attributes to a temporary set of all-cacheable access attributes;
the routine storing a copy of the one or more memory region definitions required for execution of the routine held in one or more enabled elements of the memory region definitions register into one or more spare elements of the memory region definitions register that are disabled;
atomically switching execution of the routine to a temporary context using a temporary memory map by the routine enabling the copy of the one or more memory region definitions required for execution of the routine held in the one or more spare elements of the memory region definitions register and the routine disabling the one or more memory region definitions required for execution of the routine held in the one or more enabled elements of the memory region definitions register;
the routine setting up the second memory map by storing the second set of memory region definitions in one or more predetermined elements of the memory region definitions register; and
atomically switching execution of the routine to the second context using the second memory map by the routine enabling the second set of memory region definitions in the one or more predetermined elements of the memory region definitions register and the routine disabling the copies of the memory region definitions required for execution of the routine held in the spare elements of the memory region definitions register.

At least some examples provide a computer program which, when executed on a computer, causes the computer to:
perform data processing operations comprising accesses to memory, wherein the accesses to memory are delimited by a memory map defined by a set of memory region definitions held in elements of a memory region definitions register, and wherein the accesses are controlled by a set of access attributes associated with the set of memory region definitions;
perform first data processing operations in a first context, wherein the first context uses a first memory map defined by a first set of memory region definitions held in the elements of the memory region definitions register, and wherein the accesses to the memory are controlled by a first set of access attributes; and
during the first data processing operations call a routine and initiate a transition to execution of the routine in a second context, wherein the second context uses a second memory map defined by a second set of memory region definitions held in the elements of the memory region definitions register, wherein the transition to execution of the routine comprises steps of:
initially executing the routine in the first context;
the routine disabling memory region definitions in the first set of memory region definitions held in the elements of the memory region definitions register other than at least one excepted definition, wherein the at least one excepted definition comprises one or more memory region definitions required for execution of the routine;
the routine switching from the first set of access attributes to a temporary set of all-cacheable access attributes;
the routine storing a copy of the one or more memory region definitions required for execution of the routine held in one or more enabled elements of the memory region definitions register into one or more spare elements of the memory region definitions register that are disabled;
atomically switching execution of the routine to a temporary context using a temporary memory map by the routine enabling the copy of the one or more memory region definitions required for execution of the routine held in the one or more spare elements of the memory region definitions register and the routine disabling the one or more memory region definitions required for execution of the routine held in the one or more enabled elements of the memory region definitions register;
the routine setting up the second memory map by storing the second set of memory region definitions in one or more predetermined elements of the memory region definitions register; and
atomically switching execution of the routine to the second context using the second memory map by the routine enabling the second set of memory region definitions in the one or more predetermined elements of the memory region definitions register and the routine disabling the copies of the memory region definitions required for execution of the routine held in the spare elements of the memory region definitions register.

At least some examples provide a computer-readable storage medium to store the computer program.

At least some examples provide a data processing apparatus configured to:
perform data processing operations comprising accesses to memory, wherein the accesses to memory are delimited by a memory map defined by a set of memory region definitions held in elements of a memory region definitions register, and wherein the accesses are controlled by a set of access attributes associated with the set of memory region definitions;
perform first data processing operations in a first context, wherein the first context uses a first memory map defined by a first set of memory region definitions held in the elements of the memory region definitions register, and wherein the accesses to the memory are controlled by a first set of access attributes; and
during the first data processing operations calling a routine and initiating a transition to execution of the routine in a second context, wherein the second context uses a second memory map defined by a second set of memory region definitions held in the elements of the memory region definitions register, wherein for the transition to execution of the routine the data processing apparatus is configured such that:
the routine is initially executed in the first context;
the routine disables memory region definitions in the first set of memory region definitions held in the elements of the memory region definitions register other than at least one excepted definition, wherein the at least one excepted definition comprises one or more memory region definitions required for execution of the routine;
the routine switches from the first set of access attributes to a temporary set of all-cacheable access attributes;
the routine stores a copy of the one or more memory region definitions required for execution of the routine held in one or more enabled elements of the memory region definitions register into one or more spare elements of the memory region definitions register that are disabled;
execution of the routine is atomically switched to a temporary context using a temporary memory map by the routine enabling the copy of the one or more memory region definitions required for execution of the routine held in the one or more spare elements of the memory region definitions register and the routine disabling the one or more memory region definitions required for execution of the routine held in the one or more enabled elements of the memory region definitions register;
the routine sets up the second memory map by storing the second set of memory region definitions in one or more predetermined elements of the memory region definitions register; and
execution of the routine is atomically switched to the second context using the second memory map by the routine enabling the second set of memory region definitions in the one or more predetermined elements of the memory region definitions register and the routine disabling the copies of the memory region definitions required for execution of the routine held in the spare elements of the memory region definitions register.

The present techniques will be described further, by way of example only, with reference to embodiments thereof as illustrated in the accompanying drawings, to be read in conjunction with the following description, in which:

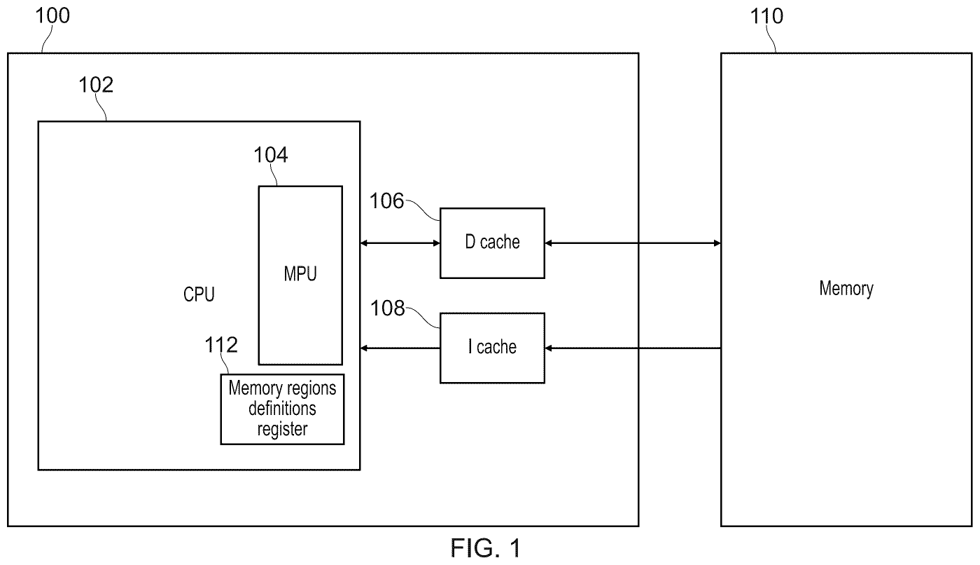

FIG. 1 schematically illustrates a data processing apparatus in accordance with some examples;

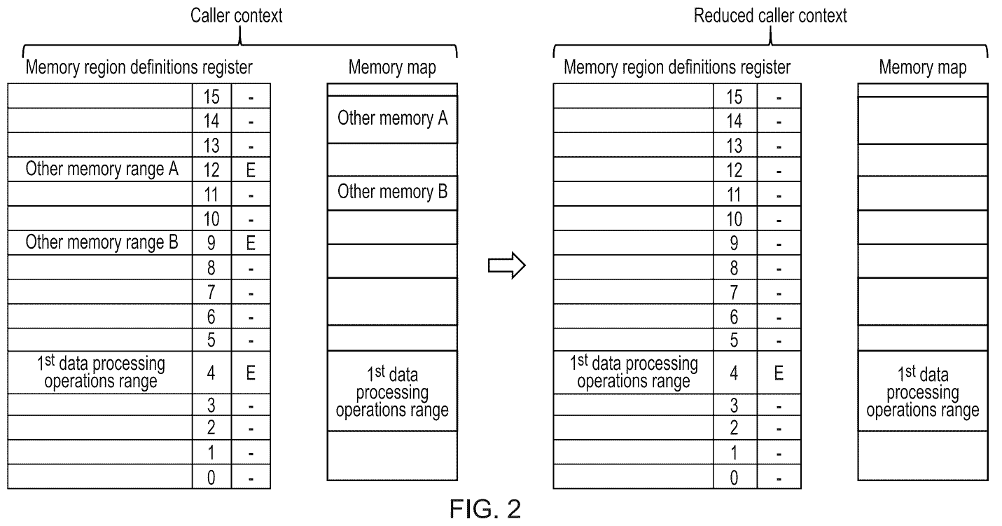

FIG. 2 illustrates some aspects of a context transition of a data processing apparatus in accordance with some examples;

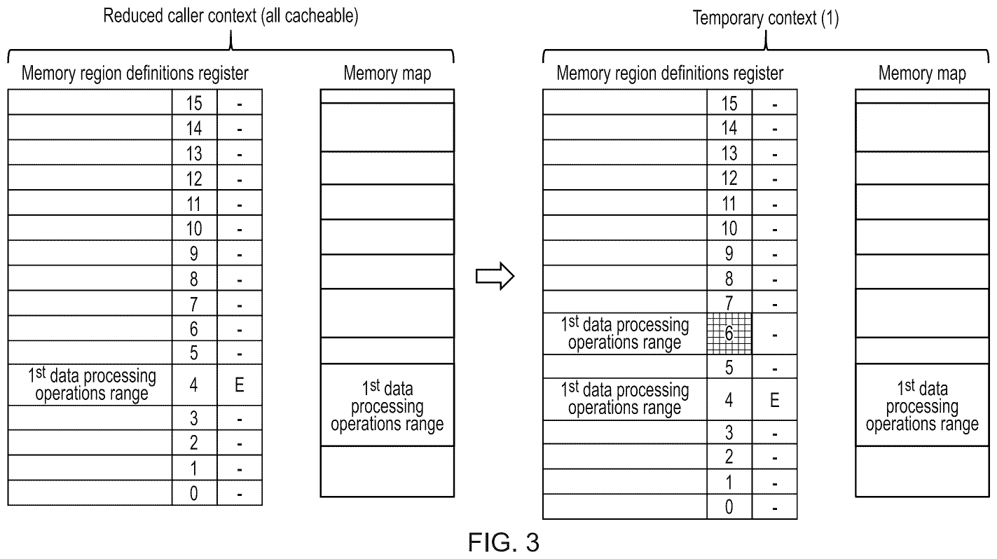

FIG. 3 illustrates some aspects of a context transition of a data processing apparatus in accordance with some examples;

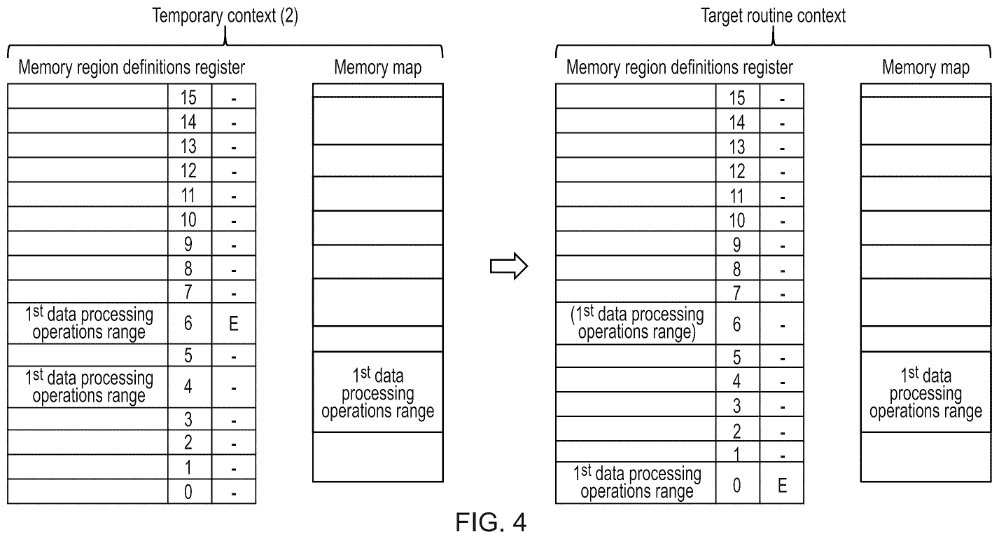

FIG. 4 illustrates some aspects of a context transition of a data processing apparatus in accordance with some examples;

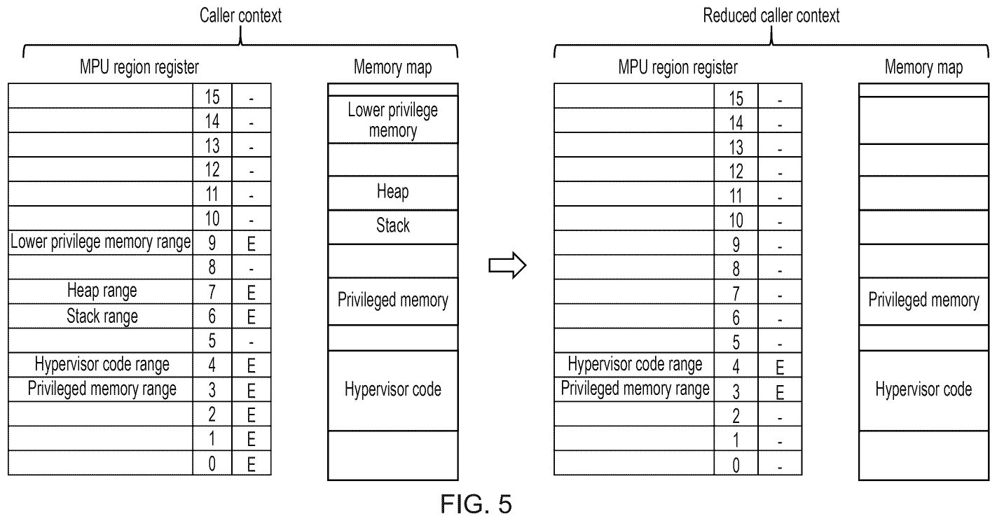

FIG. 5 illustrates some aspects of a context transition of a data processing apparatus in accordance with some examples;

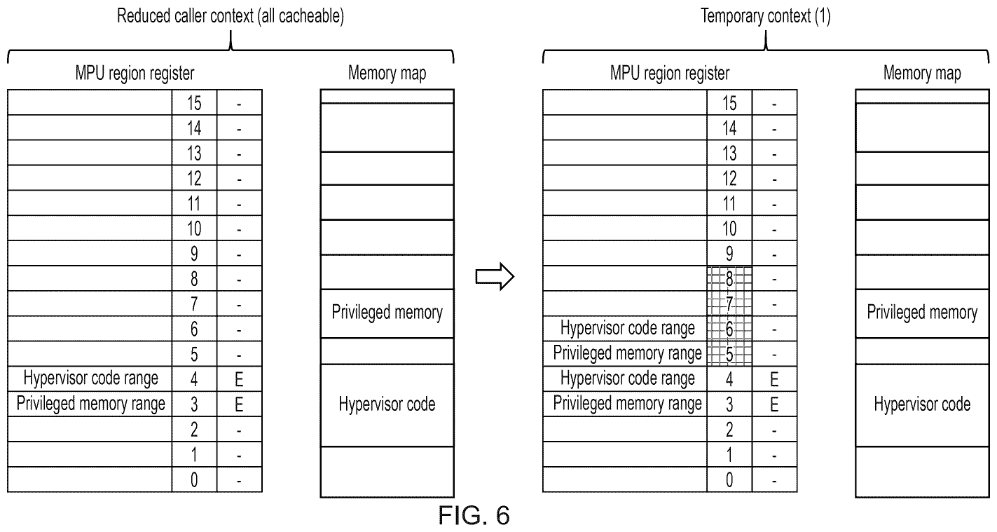

FIG. 6 illustrates some aspects of a context transition of a data processing apparatus in accordance with some examples;

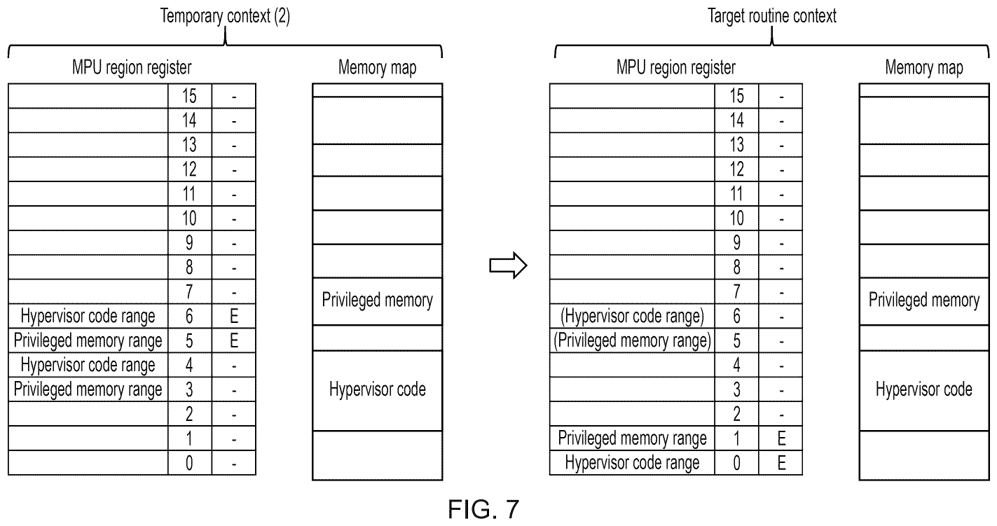

FIG. 7 illustrates some aspects of a context transition of a data processing apparatus in accordance with some examples;

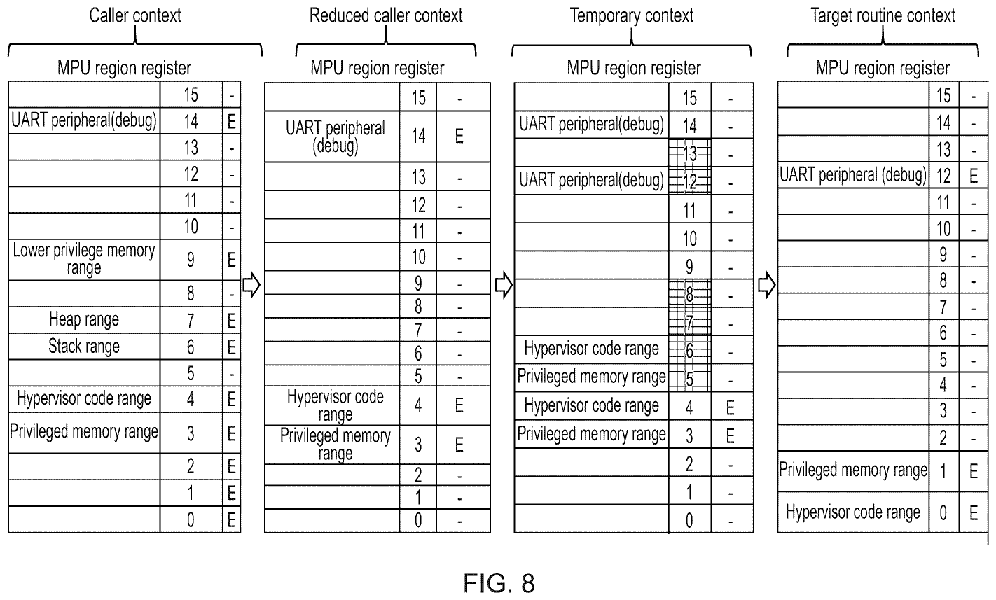

FIG. 8 illustrates some aspects of context transition of a data processing apparatus in accordance with some examples;

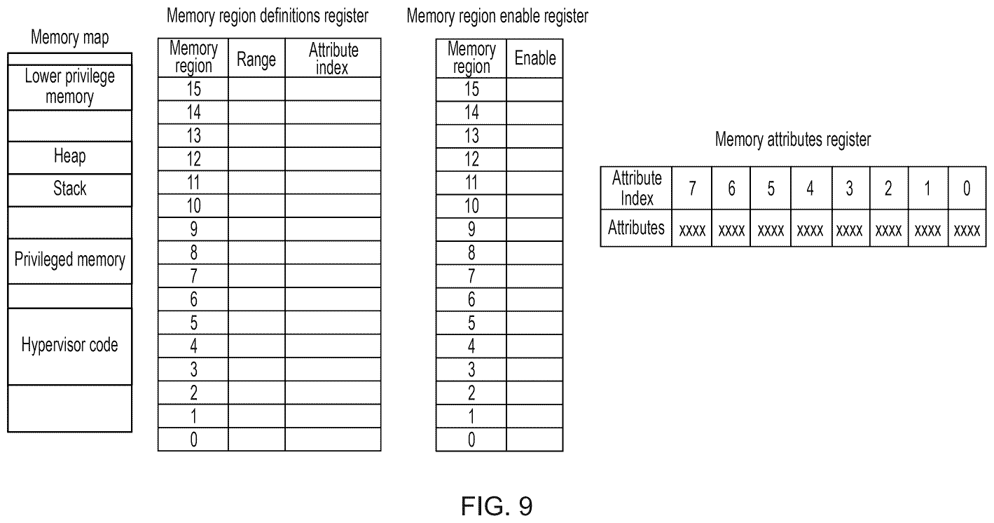

FIG. 9 schematically illustrates a memory map, a memory region definitions register, and a memory attributes register of a data processing apparatus in accordance with some examples; and

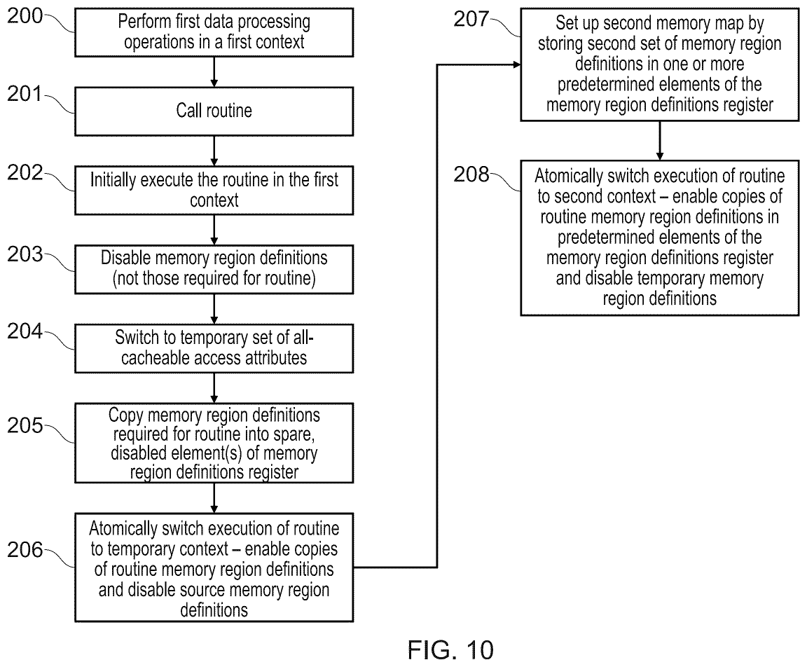

FIG. 10 is a flow diagram showing a sequence of steps which are taken in a method in in accordance with some examples;

In one example herein there is a method of operating a data processing apparatus comprising:
performing data processing operations comprising accesses to memory, wherein the accesses to memory are delimited by a memory map defined by a set of memory region definitions held in elements of a memory region definitions register, and wherein the accesses are controlled by a set of access attributes associated with the set of memory region definitions;
performing first data processing operations in a first context, wherein the first context uses a first memory map defined by a first set of memory region definitions held in the elements of the memory region definitions register, and wherein the accesses to the memory are controlled by a first set of access attributes; and
during the first data processing operations calling a routine and initiating a transition to execution of the routine in a second context, wherein the second context uses a second memory map defined by a second set of memory region definitions held in the elements of the memory region definitions register, wherein the transition to execution of the routine comprises steps of:
initially executing the routine in the first context;
the routine disabling memory region definitions in the first set of memory region definitions held in the elements of the memory region definitions register other than at least one excepted definition, wherein the at least one excepted definition comprises one or more memory region definitions required for execution of the routine;
the routine switching from the first set of access attributes to a temporary set of all-cacheable access attributes;
the routine storing a copy of the one or more memory region definitions required for execution of the routine held in one or more enabled elements of the memory region definitions register into one or more spare elements of the memory region definitions register that are disabled;
atomically switching execution of the routine to a temporary context using a temporary memory map by the routine enabling the copy of the one or more memory region definitions required for execution of the routine held in the one or more spare elements of the memory region definitions register and the routine disabling the one or more memory region definitions required for execution of the routine held in the one or more enabled elements of the memory region definitions register;
the routine setting up the second memory map by storing the second set of memory region definitions in one or more predetermined elements of the memory region definitions register; and
atomically switching execution of the routine to the second context using the second memory map by the routine enabling the second set of memory region definitions in the one or more predetermined elements of the memory region definitions register and the routine disabling the copies of the memory region definitions required for execution of the routine held in the spare elements of the memory region definitions register.

The ability for a data processing apparatus to switch execution from one context to another context enables the data processing apparatus to multitask by running multiple processes in a time duplexed manner. Nevertheless, these multiple processes may often need isolation from one another in terms of the data that they respectively access to ensure the integrity of those processes. The access by a process to selected memory regions may be controlled by a memory protection unit (MPU), whereby a set of memory region definitions is held in the elements of a memory region definitions register define a memory map for a given process. Moreover, accesses to memory regions so defined are further controlled by an associated set of access attributes. The MPU checks these access attributes (permissions) for data and instruction accesses for a current translation regime. For data, it ensures that the access (either read or write as appropriate) is allowed. For instructions, it checks both region access and execution permissions. In order to ensure the isolation of the respective processes from one another, when switching between contexts it is usual for all of the set of memory region definitions held in the elements of the memory region definitions register to be disabled when exiting one context (the current translation regime), before a new set of memory region definitions are enabled in the elements of the memory region definitions register to support the new context (a target translation regime). Another aspect of ensuring that appropriate isolation between processes is maintained concerns the use of a data cache by the data processing apparatus, in which data accessed from memory is temporarily stored to reduce access latency. Generally, in order to ensure the isolation of the respective processes from one another, when switching between contexts at least some cache maintenance operations are required between exiting the first context and starting the new context. In particular, architectural rules typically require that any change to the memory region attributes that includes non-cacheable status means that the entire cache must be cleared for the context switch to proceed. However, such translation disabling and cache maintenance operations take time which delays the switch from the first context to the new context. Moreover, cache maintenance operations render the execution time less deterministic, which may be undesirable for some types of data processing such as real-time processing.

The inventor of the present techniques has realised that a method for switching between performing first data processing operations in a first context to performing second data processing operations in a second context can be followed which avoids the need for wholesale translation disabling or the performance of cache maintenance operations. Accordingly this mitigates against the abovementioned delays and lack of time determinism. As set out herein, the method comprises calling a routine whilst initially operating in a first context and then selectively disabling memory region definitions (avoiding disabling those that are required for continued operation of the routine). Then execution switches to use of a temporary set of all-cacheable access attributes and the memory region definitions required for continued execution of the routine are copied into one or more spare (now-disabled) element(s) of the memory region definitions register. Execution of the routine is then atomically switched to a temporary context by enabling the copies of the routine memory region definitions (whilst disabling the original versions of the memory region definitions). A new memory map is then established by storing a new set of memory region definitions in one or more predetermined elements of the memory region definitions register. Execution of the routine is then atomically switched to the second context by enabling the copies of the routine memory region definitions in those predetermined elements of the memory region definitions register and disabling the temporary memory region definitions.

Although the execution in the second context can then already proceed, making use of the temporary set of all-cacheable access attributes, in some examples the transition to execution of the routine in the second context further comprises a step of switching from the temporary set of all-cacheable access attributes to a second set of access attributes which are to be used for further execution of the routine in the second context following the transition.

Accordingly, this provides the opportunity to continue the execution of the routine in the second context using access attributes which are not all-cacheable, and in some examples the second set of memory region definitions held in the elements of the memory region definitions register comprises at least one temporary storage memory region, and the second set of access attributes defines the temporary storage memory region as non-cacheable. Such a non-cacheable temporary storage memory region can therefore provide a region with “device” (non-cacheable) attributes, as may for example be required by a universal asynchronous receiver/transmitter (UART) channel provided for diagnostic purposes.

It is further recognised here that when the routine stores the copy of the one or more memory region definitions required for execution of the routine into one or more spare (disabled) elements of the memory region definitions register, the routine does not know which regions the caller of the routine has used, and therefore which regions are assured to be free for the copies. To address this, in some examples the one or more spare elements of the memory region definitions register are selected from a predetermined double set of candidate elements of the memory region definitions register, wherein the predetermined double set of candidate elements has twice the number of elements as the one or more spare elements of the memory region definitions register. Accordingly, regardless of which regions the caller of the routine uses, there will be sufficient free regions where the copies can be set up.

In some examples, the initially executing the routine in the first context comprises the routine saving the first context and the routine determining from the first memory map the one or more memory region definitions required for execution of the routine. Accordingly the routine, when called and still running in the first context (from which it was called), is then responsible for saving the first context (such that it can be returned to when switching back from the operation in the second context) and also determining which memory region definitions (held in elements of the memory region definitions register) are required for the execution of the routine with reference to the memory map that those memory region definitions define.

In some examples this determining from the first memory map the one or more memory region definitions required for execution of the routine comprises the routine determining from operands of a function call that called the routine memory addresses defining a memory region used for the routine. Accordingly, the operands of the function call allow an identification of the memory locations required to be accessed, and hence by correlating those locations with the memory map this allows an identification of memory region definitions used for the routine (i.e. which elements of the memory region definitions register hold the definitions required).

In some examples the one or more memory region definitions required for execution of the routine is a subset of the first set of memory region definitions. Accordingly there may be further memory region definitions enabled in the first context as well as those that are required for execution of the routine. As such the copying of the memory region definitions may in some examples only involve a subset of the first set of memory region definitions.

In some examples the method further comprises, when performing the first data processing operations in the first context, prior to calling the routine, calling a diagnostic function to cause the data processing apparatus to operate in a diagnostic mode, wherein the at least one excepted definition comprises at least one further memory region definition required for operating in the diagnostic mode held in at least one further element of the memory region definitions register. Hence, by virtue of the fact that the memory region required for operating in the diagnostic mode is an excepted definition, this region will not be disabled by the routine when the context switch is performed, thus allowing the diagnostic capabilities to continue uninterrupted.

The at least one further memory region definition required for operating in the diagnostic mode may be used in a variety of ways, but in some examples the at least one further memory region definition required for operating in the diagnostic mode defines a memory region allocated to a peripheral device, wherein the memory region allocated to the peripheral device is non-cacheable, and wherein the routine switching from the first set of access attributes to the temporary set of all-cacheable access attributes excludes the memory region allocated to the peripheral device.

In some examples the data processing apparatus is configured to communicate with the peripheral device using universal asynchronous receiver/transmitter protocol (UART).

The mechanism for enabling and disabling selected memory region definitions may take a variety of forms, but in some examples the data processing apparatus comprises a memory region enable register, wherein respective elements of the memory region enable register correspond to respective elements of the memory region definitions register, and wherein a bit value held in each of the respective elements of the memory region enable register determines whether respective memory region definitions held in the elements of the memory region definitions register are enabled or not, wherein atomically switching execution of the routine to the temporary context comprises writing the elements of the memory region enable register, and wherein atomically switching execution of the routine to the second context comprises writing the elements of the memory region enable register. Accordingly, where the elements of the memory region enable register can be written in a single atomic operation, this provides a reliable mechanism for modifying memory region definitions in an atomic operation, ensuring that certain definitions can be enabled and other definitions disabled in a single atomic step.

The set of access attributes that is associated with a given set of memory region definitions may be administered in a variety of ways, but in some examples the data processing apparatus comprises a memory region attribute register, wherein elements of the memory region attribute register correspond to respective elements of the memory region definitions register, and wherein content of the elements of the memory region attribute register defines the set of access attributes associated with the set of memory region definitions.

The configuration of the access attributes associated with the set of memory region definitions may be achieved in a variety of ways, but in some examples the data processing apparatus comprises a memory attribute indirection register, wherein elements of the memory attribute indirection register hold sets of access attributes, and wherein the elements of the memory region attribute register comprise element indicators referring to the elements of the memory attribute indirection register. Accordingly this simplifies the modification and switching of sets of access attributes.

In some examples the routine switching from the first set of access attributes to the temporary set of all-cacheable access attributes comprises performing a write to the elements of the memory attribute indirection register to set all-cacheable access attributes.

Various techniques may then further be employed in modifying the elements of the memory attribute indirection register to allow improved control over the access attributes. In some examples, performing the write to the elements of the memory attribute indirection register comprises masking at least one element in the memory attribute indirection register referred to by at least one element indicators of the memory region attribute register associated with the peripheral device.

In some examples, performing the first data processing operations in the first context comprises the data processing apparatus operating in a privileged mode, and wherein in transitioning to execution of the routine in the second context the data processing apparatus remains in the privileged mode.

In one example herein there is a computer program which, when executed on a computer, causes the computer to:
perform data processing operations comprising accesses to memory, wherein the accesses to memory are delimited by a memory map defined by a set of memory region definitions held in elements of a memory region definitions register, and wherein the accesses are controlled by a set of access attributes associated with the set of memory region definitions;
perform first data processing operations in a first context, wherein the first context uses a first memory map defined by a first set of memory region definitions held in the elements of the memory region definitions register, and wherein the accesses to the memory are controlled by a first set of access attributes; and
during the first data processing operations call a routine and initiate a transition to execution of the routine in a second context, wherein the second context uses a second memory map defined by a second set of memory region definitions held in the elements of the memory region definitions register, wherein the transition to execution of the routine comprises steps of:
initially executing the routine in the first context;
the routine disabling memory region definitions in the first set of memory region definitions held in the elements of the memory region definitions register other than at least one excepted definition, wherein the at least one excepted definition comprises one or more memory region definitions required for execution of the routine;
the routine switching from the first set of access attributes to a temporary set of all-cacheable access attributes;
the routine storing a copy of the one or more memory region definitions required for execution of the routine held in one or more enabled elements of the memory region definitions register into one or more spare elements of the memory region definitions register that are disabled;
atomically switching execution of the routine to a temporary context using a temporary memory map by the routine enabling the copy of the one or more memory region definitions required for execution of the routine held in the one or more spare elements of the memory region definitions register and the routine disabling the one or more memory region definitions required for execution of the routine held in the one or more enabled elements of the memory region definitions register;
the routine setting up the second memory map by storing the second set of memory region definitions in one or more predetermined elements of the memory region definitions register; and
atomically switching execution of the routine to the second context using the second memory map by the routine enabling the second set of memory region definitions in the one or more predetermined elements of the memory region definitions register and the routine disabling the copies of the memory region definitions required for execution of the routine held in the spare elements of the memory region definitions register.

In one example herein there is a computer-readable storage medium to store the computer program.

In one example herein there is a data processing apparatus comprising:
data processing circuitry configured to perform data processing operations, wherein the data processing circuitry has access to a memory region definitions register, wherein the data processing circuitry is configured to:
perform the data processing operations comprising accesses to memory, wherein the accesses to memory are delimited by a memory map defined by a set of memory region definitions held in elements of the memory region definitions register, and wherein the accesses are controlled by a set of access attributes associated with the set of memory region definitions;
perform first data processing operations in a first context, wherein the first context uses a first memory map defined by a first set of memory region definitions held in the elements of the memory region definitions register, and wherein the accesses to the memory are controlled by a first set of access attributes; and
during the first data processing operations calling a routine and initiating a transition to execution of the routine in a second context, wherein the second context uses a second memory map defined by a second set of memory region definitions held in the elements of the memory region definitions register, wherein for the transition to execution of the routine the data processing apparatus is configured such that:
the routine is initially executed in the first context;
the routine disables memory region definitions in the first set of memory region definitions held in the elements of the memory region definitions register other than at least one excepted definition, wherein the at least one excepted definition comprises one or more memory region definitions required for execution of the routine;
the routine switches from the first set of access attributes to a temporary set of all-cacheable access attributes;
the routine stores a copy of the one or more memory region definitions required for execution of the routine held in one or more enabled elements of the memory region definitions register into one or more spare elements of the memory region definitions register that are disabled;
execution of the routine is atomically switched to a temporary context using a temporary memory map by the routine enabling the copy of the one or more memory region definitions required for execution of the routine held in the one or more spare elements of the memory region definitions register and the routine disabling the one or more memory region definitions required for execution of the routine held in the one or more enabled elements of the memory region definitions register;
the routine sets up the second memory map by storing the second set of memory region definitions in one or more predetermined elements of the memory region definitions register; and
execution of the routine is atomically switched to the second context using the second memory map by the routine enabling the second set of memory region definitions in the one or more predetermined elements of the memory region definitions register and the routine disabling the copies of the memory region definitions required for execution of the routine held in the spare elements of the memory region definitions register.

Some particular embodiments are now described with reference to the figures.

FIG. 1 schematically illustrates a data processing apparatus 100 in accordance with some examples. Only the primary components of the data processing apparatus 100 of relevance to the present disclosure are shown, namely a CPU 102, a memory protection unit (MPU) 104), a data cache 106, an instruction cache 108, and a memory region definitions register 112. The data processing apparatus 100 has access to a memory 110, from which it retrieves data values and instructions, the instructions defining the data processing operations to be carried out using the retrieved data values. Data values that are modified by the execution of the instructions are returned to the memory 110 for storage. When executing a sequence of instructions to perform data processing operations, the data processing apparatus is operating in a defined context. One aspect of the context in which the data processing apparatus is operating is the memory map which the context uses, this defining the view of memory that the data processing apparatus has. The memory map is defined by a set of memory region definitions that are held in the elements of the memory region definitions register 112. The set of memory region definitions delimits the regions of memory that are accessible to the data processing operations in this context and furthermore accesses to the memory are controlled by a set of access attributes associated with the set of memory region definitions (for example specifying whether a given region of memory is read/write accessible or whether instructions stored there are executable). The data processing apparatus 100 is configured to be able to switch between processing contexts, whereby (in a manner with which one of ordinary skill in this technical field is familiar) the processor state at the point of exit of a first context is saved, such that data processing may be carried out for a period in a second context, before returning to the data processing in the first context by restoring that first context. As mentioned above however, in order to preserve the integrity/security of data between contexts, it is usual for memory region definitions (as defined in the memory region definitions register) to be disabled in a first context as the transition to a second context occurs (in which a new set of memory region definitions will be enabled in the memory region definitions register) and for cache maintenance operations to be required, e.g. in accordance with architectural rules that cache maintenance is required when the memory type, cacheability, or shareability attributes for a memory location are changed when memory region definitions change. These cache maintenance operations are typically invalidating the whole instruction cache and cleaning/invalidating the whole data cache. The data processing apparatus 100 is configured such that when first data processing operations are being carried out in a first context, a routine can be called which will involve a transition to execution of the routine in a second context, whereby these performance-delays associated with wholesale memory region definition disabling and cache maintenance operations are avoided. The process is described in the following with respect to the accompanying figures.

FIG. 2 illustrates some aspects of a context transition of a data processing apparatus in accordance with some examples. The data processing apparatus is initially in a “caller context” (a first context) which uses a first memory map defined by a first set of memory region definitions held in the elements of the memory region definitions register. This first memory map comprises three distinct regions: a first data processing operations range, “other memory A”, and “other memory B”. These regions are respectively defined in three elements 4, 9, and 12 of the memory region definitions register. Each element defines the range of memory addresses comprised in the respective region, as well as an indicator (‘E’) defining which elements (and hence memory regions) are currently enabled. A single bit may provide this indicator. Accesses to the respective memory regions are controlled by a first set of access attributes, which may be directly provided by the respective elements of the memory region definitions register or may be indirectly referenced from those respective elements. During the first data processing operations in the caller context a call is made to a routine, and this initiates a transition to execution of the routine in a second context. Initially the routine is executed in the first context (the “caller context”). The routine then disables the memory region definitions in the first set of memory region definitions other than at least one excepted definition required for execution of the routine. Thus in this example definitions 9 and 12 are disabled, whilst definition 4 remains enabled. The routine is then executing in a “reduced caller context”.

FIG. 3 illustrates some further aspects of a context transition of a data processing apparatus in accordance with some examples. The left-hand side of the figure shows the status of the memory region definitions register and the corresponding memory map. As a further step at this stage, the routine switches from the first set of access attributes to a temporary set of all-cacheable access attributes, i.e. where previously the first set of access attributes associated with the first set of memory region definitions may have had any configuration of access attributes, now the temporary set of all-cacheable access attributes specifies that all memory regions are all-cacheable. This has the advantage that in proceeding further with the context switching, architectural rules for the processor concerning changes to access attributes are not invoked, in particular any that mandate that any change to the memory region attributes that includes a non-cacheable status must be accompanied by clearing the cache. Next the routine copies the one or more memory region definitions required for execution of the routine in the enabled elements of the memory region definitions register into one or more spare elements of the memory region definitions register that are currently disabled. In the example of FIG. 3, the required memory region definition is that held in element 4 of the memory region definitions register and this is copied into element 6 of the memory region definitions register. The right-hand side of FIG. 3 thus shows the first part of a transition from the “reduced caller context” with associated all-cacheable access attributes (on the left-hand side) to a temporary context.

The second first part of the transition from the “reduced caller context” to the temporary context is shown on the left-hand side of FIG. 4, where an atomic switch has been caused by the routine, in that it has in a single step enabled the copy of the memory region definition required for execution of the routine held in element 6 of the memory region definitions register and disabled the original memory region definition used for execution of the routine held in element 4 of the memory region definitions register. Once this is done the routine sets up the new memory map for the target routine context (the “second context”) by storing the second set of memory region definitions in one or more predetermined elements of the memory region definitions register. Here the required first data processing operations range is stored in element 0 of the memory region definitions register. It should be noted that the “first data processing operations range” region defined for use (by element 0 of the memory region definitions register) in the target routine context need not be identical to the “first data processing operations range” region defined for the original (caller)/temporary contexts (by element 4 of the memory region definitions register). Indeed in some examples, the size of this region in the target routine context is a subset of the original “first data processing operations range” region defined for the original (caller) context. Then, as shown in FIG. 4 on the right-hand side, the routine then causes an atomic switch of the routine from the temporary context to the second (target) context using the new memory map by, in a single step enabling the new memory region definition in the element 0 of the memory region definitions register and disabling the copy of the memory region definition required for execution of the routine held in the spare element (element 6) of the memory region definitions register. As a consequence, the routine is then executing in the target second context, having switched there from the first (caller) context, but without requiring wholesale translations disabling or cache maintenance operations. In addition, the context switch may also be accompanied by a further step of switching from the temporary set of all-cacheable access attributes to a second set of access attributes which are to be used for further execution of the routine in the second context following the switch.

A further example context switch in some examples of the present techniques is illustrated in FIGS. 5-7. This follows the same basic set of stages as the context switch illustrated with reference to FIG. 2-4. This example begins when code executing in a first context is operating in a privileged mode of operation for the data processing apparatus. More specifically, a hypervisor is executing in a correspondingly privileged mode of operation and it is the hypervisor that calls the target routine which is ultimately (following the context switch) to execute in the target context. Initially, as shown on the left-hand side of FIG. 5, the hypervisor (the caller) is operating in a context for which five elements of the MPU region register (the memory region definitions register) are active (enabled). These define: a memory region (element 4) in which the hypervisor code is stored; a memory region (element 5) of privileged memory to which only privileged processes (such as the hypervisor) have access; a general purpose lower privilege memory range (element 9); a memory range used for the stack (element 6); and a memory range used for the heap (element 7). The hypervisor calls a routine which is also to operate in the privileged mode of operation. Initially the routine is executing in the original (first) context in which the hypervisor was operating. The routine determines checks the memory region definitions that are currently in use to confirm if they cover regions required for execution of the routine and records the MPU regions that correspond to the required regions of memory. The required regions of memory can be determined by the routine from the operands of a function call that called the routine to yield the memory addresses defining a memory region used for the routine. The routine then disables those memory region definitions in the first set of memory region definitions held in the MPU region register that are not required for execution of the routine, thus moving the execution state into a reduced caller context (right-hand side of FIG. 5). Thus the hypervisor code range and the privileged memory range remain enabled. On the left-hand side in FIG. 6 the same status of the MPU region register is shown, although this is accompanied by the access attributes in use being a temporary set of all-cacheable access attributes. Note that the set of access attributes in use may directly form part of the content of the MPU region register (the memory region definitions register) or may be stored in an associated data structure. More detail of such examples is given below with reference to FIG. 9. Next, the called routine copies those memory region definitions required for execution of the routine into one or more spare elements of the memory region definitions register that are disabled. In this example, the memory region definition in elements 4 and 5 are copied, where elements 5, 6, 7, and 8 were candidates for the target elements into which the content of elements 4 and 5 might be copied. Note therefore that a predetermined double set of candidate elements of the MPU region register are used. This double set (i.e. two candidate elements per element to be copied) ensures that whichever MPU region register elements are in use (and required for execution of the routine), at least one each of the pair of candidate elements will be available. In this example, elements 5 and 6 are selected, and the memory region definitions for the hypervisor code range and the privileged memory range are copied into them. Then, moving to considering the left-hand side of FIG. 7, the routine atomically switches execution of the routine to the temporary context by enabling the copies (in elements 5 and 6) and disabling the originals (in elements 3 and 4). As the final steps of the context switch, the routine first sets up the target memory map by storing the required new set of memory region definitions in one or more predetermined elements (in this case, 0 and 1) of the MPU region register. It should also be noted here that the “hypervisor code range” and “privileged memory range” regions defined for use (by elements 0 and 1 of the MPU region register) in the target routine context need not be identical to the “hypervisor code range” and “privileged memory range” regions defined for the original (caller)/temporary contexts (by elements 3 and 4 of the MPU region register). Indeed in some examples, the size of these regions in the target routine context is a subset of their size as defined for the original (caller) context. Then, moving to considering the right-hand side of FIG. 7, the routine atomically switches execution of the routine to the target context by enabling the new definitions (in elements 0 and 1) and disabling the temporary copies (in elements 5 and 6). The target memory map can also be expanded to more regions than just the two, for example in debug mode an additional region is used for an address to print to (e.g. a UART). Each additional region to save just requires an extra two scratch regions (candidate elements of the MPU region register for the copies) to ensure that there can always be a spare region if one of the scratch regions is in use by caller code. Again, the context switch may also be accompanied by a further step of switching from the temporary set of all-cacheable access attributes to a second set of access attributes which are to be used for further execution of the routine in the second context following the switch. An additional region for use by a UART is defined as non-cacheable.

FIG. 8 illustrates some aspects of context transition of a data processing apparatus in accordance with some examples. In particular, the incorporation of a debug mode and a corresponding UART peripheral having a defined memory region is shown. In this example, the data processing apparatus also provides diagnostic capability for the user. One aspect of the diagnostic capability comprises a diagnostic function being called, which causes the data processing apparatus to operate in a diagnostic mode. This diagnostic function is called in the original caller context (as applies to the furthest left portion of FIG. 8). Another aspect of the diagnostic capability comprises a UART peripheral being available to the data processing apparatus, in particular as a channel via which diagnostic information can be written out by the apparatus. This UART peripheral is allocated part of the memory range visible to the apparatus, as is shown in the furthest left portion of FIG. 8 by the memory region definition in element 14 of the MPU region register. This region is treated as a temporary storage memory region. The progression of the context switching illustrated in FIG. 8 follows a similar sequence to that discussed with reference to FIGS. 5-7, and a full repeat of that description is not made here for brevity. However, the additional feature of this context switching is the inclusion of the memory region allocated to the UART peripheral, which it will be noted from the first transition in FIG. 8 (from the caller context to the reduced caller context) does not get disabled in this transition and indeed persists in the same manner as the hypervisor code range and the privileged memory range. Accordingly, in the temporary context, the memory region definition for the UART peripheral memory range is also copied into a spare element of the MPU region register in the same manner as the hypervisor code range definition and the privileged memory range definition.

Indeed the same doubling of candidate elements from which the spare element is selected is also employed to ensure that this copying can proceed, where the spare element in to which memory region definition for the UART peripheral memory range is also copied is selected from the candidate elements 12 and 13. A further point to note with regard to this context switching with a memory region definition for a UART peripheral is that the memory region allocated to the peripheral device is non-cacheable (i.e. is allocated non-cacheable access attributes), this being the required configuration for such a peripheral. Accordingly, the non-cacheable status of this region means that accesses to the region are not looked up in any cache, but are sent directly to memory (i.e. directly to the UART peripheral). To support this, when the routine switches from the set of access attributes originally in place in the caller context to the temporary set of all-cacheable access attributes, the memory region allocated to the peripheral device is excluded (thus meaning non-cacheable). Hence once the target routine context is reached (far right of FIG. 8) the memory region definition for the UART peripheral memory range persists and thus the debug channel provided by the UART peripheral similarly persists. Once more, the context switch may also be accompanied by a further step of switching from the temporary set of all-cacheable access attributes to a second set of access attributes which are to be used for further execution of the routine in the second context following the switch.

FIG. 9 schematically illustrates a memory map, a memory region definitions register, a memory region enable register, and a memory attributes register of a data processing apparatus in accordance with some examples. The example memory map on the left-hand side corresponds to that shown and discussed with reference to FIGS. 5-8. The memory region definitions register (MPU region register) comprises a set of 16 elements, each of which is configured to hold a memory range definition and an attribute index. The memory range definitions define the range of memory addresses comprised in each memory region. The enabling/disabling of each memory range definition is controlled by the memory region enable register, which holds a value each bit of which corresponds to one of the elements of the memory region definitions register. The setting/unsetting of the corresponding enable bit enables/disables that memory region definition. In other examples, the enable bits may be provided as part of each entry in the memory region definitions register. The elements of the memory region definitions register each hold an attribute index, which is an indirection mechanism, whereby the access attributes associated with a given memory region are not directly defined in the corresponding element of the memory region definitions register, but rather with reference to a separate memory attributes register. The example memory attributes register in FIG. 9 has eight elements, each of which stores an indication of a set of access attributes. The number of defined access attributes is not limited to 8 and could vary in other implementations. Hence, a given element in the memory region definitions register has an attributes index value, and this indicates which of the elements of the memory attributes register provides the access attributes for that memory region definition. The use of the memory attributes register also supports the described mechanisms for changing access attributes. Firstly, when an all-cacheable set of access attributes is required, this can readily be achieved by modifying the contents of the memory access register to be all-cacheable. Secondly, when any given element of the memory attributes register is to be excluded from the general all-cacheable status, as in the case of the UART peripheral describe above, this can be achieved by masking the corresponding element(s) in the memory attribute register, when updating the rest of the attributes to all-cacheable.

An example usage of the present techniques is now described, for when a software test library (STL) is called and a corresponding context switch according to the present techniques is made, when running on a real-time processor. It is desirable to switch context from the calling context to a specific context designed to run the STL and the present techniques allow switching between these contexts without requiring disabling translation or caches and without requiring any cache maintenance. This allows switching between the contexts more quickly. This may be particularly important for the STL running on a real-time core, because interrupts are disabled while the STL is running. Additionally cache maintenance would make the execution time less deterministic, which is undesirable for a STL running on a real-time core. When the software test library (STL) is called by software running at the highest privilege level on the processor (e.g. a hypervisor), the scheduler (part of the STL) will need to save the calling context and set up a new context suitable for running the STL. As the STL runs at the highest privilege it will be running at the same privilege level as the software that calls it.

Initially the STL runs in the caller context, and so MPU regions must be set up (in the sixteen elements of the MPU region register) to cover the STL library code and a region of memory allocated to the STL that holds the stack and any global data used by this instance of the STL (referred to as the “configuration object”). When the STL saves the caller context for translation (e.g. the MPU region registers) it checks each of the regions to confirm if they cover the library code or the configuration object. The STL will record the two MPU regions that correspond to these regions of memory. Next the STL then disables all MPU regions other than those used for the code and the configuration object, and setup a “permissive” value in a memory attribute indirection register (MAIR) so that all attributes will be inner/outer WB (all cacheable at any cache levels in the processor and any cache levels external to the core or cluster to which the processor belongs). The STL then sets up copies of the code and configuration object regions in two of four scratch (candidate spare elements) MPU regions (chosen as MPU regions 10-13 to not conflict with the STL setup). As there are two MPU regions to be set up, regardless of which MPU regions the caller uses, there will be two free MPU regions where the copies can be set up. These copies are initially setup as disabled, so they do not conflict with the caller MPU regions. The STL then writes to the protection region enable register (memory region enable register) PRENR_ELx register (where ELx indicates the privilege level) to atomically switch from using the caller MPU regions to the new temporary MPU regions which are set up in the scratch regions (candidate spare elements) by disabling the caller regions and enabling the temporary regions. These temporary regions have the same address as the caller regions so the attributes of any memory accesses from running software do not have any mismatched attributes compared to earlier accesses. Now that it is guaranteed that the MPU regions that are in use are in the range 10-13, the STL MPU regions for the library code and the configuration object can be set up as region 0 and 1 and with the required attributes and permissions for the STL but disabled. There will then be a second atomic switch to disable the temporary MPU regions and enable the STL MPU regions. Note that there may also be additional MPU regions for scratchpads and peripherals. As the access attributes in use do not change, it is possible for software to keep executing without having to perform any maintenance of translations or the caches, making the entry to the STL context more deterministic and reducing the duration of disabling interrupts. The technique can also be expanded to more regions than just the two, for example in debug mode an additional region is used for an address to print to (e.g. a UART). Each additional region to save just requires an extra two scratch regions (candidate spare elements) to ensure that there can always be a spare region if one of the scratch regions is in use by caller code.

FIG. 10 is a flow diagram showing a sequence of steps which are taken in a method in in accordance with some examples. The steps begin at step 200, where data processing operations are performed in a first context. At step 201, a routine is called (which is ultimately to be executed in a second context). Initially at step 202 the routine executes in the first context. Then at step 203, the routine disables memory region definitions, excepting one or more memory region definitions required for the execution of the routine. At step 204 the routine switching from a first set of access attributes to a temporary set of all-cacheable access attributes. Then at step 205, the routine copies the one or more memory region definitions required for execution of the routine into one or more spare elements of the memory region definitions register (which are currently disabled). At step 206 an atomic switch of execution of the routine to a temporary context using a temporary memory map is carried out, by the routine enabling the copy of the one or more memory region definitions required for execution of the routine and disabling the original versions. Next at step 207 the routine sets up a second memory map by storing a second set of memory region definitions in one or more predetermined elements of the memory region definitions register. Finally at step 208 another atomic switch is carried out, switching execution of the routine to the second context using the second memory map by enabling new second set of memory region definitions and disabling the temporary copies of the memory region definitions.

In brief overall summary, methods of context switching, and corresponding computer programs, storage media, and apparatuses are disclosed. Data processing operations are performed in a first context and a routine is called which is to be executed in a second context. Initially the routine executes in the first context. Then memory region definitions other than those required for execution of the routine are disabled. A temporary switch is made to a set of all-cacheable memory access attributes. Then memory region definitions required for execution of the routine are copied into one or more spare elements of a memory region definitions register. An atomic switch of execution of the routine to a temporary context using a temporary memory map is carried out, by enabling the copy of the one or more memory region definitions required for execution of the routine and disabling the original versions. Then a second memory map is set up by storing a second set of memory region definitions in one or more predetermined elements of the memory region definitions register. Finally another atomic switch is carried out, switching execution of the routine to the second context using the second memory map by enabling new second set of memory region definitions and disabling the temporary copies of the memory region definitions.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

1. A method of operating a data processing apparatus comprising:
performing data processing operations comprising accesses to memory, wherein the accesses to memory are delimited by a memory map defined by a set of memory region definitions held in elements of a memory region definitions register, and wherein the accesses are controlled by a set of access attributes associated with the set of memory region definitions;
performing first data processing operations in a first context, wherein the first context uses a first memory map defined by a first set of memory region definitions held in the elements of the memory region definitions register, and wherein the accesses to the memory are controlled by a first set of access attributes; and
during the first data processing operations calling a routine and initiating a transition to execution of the routine in a second context, wherein the second context uses a second memory map defined by a second set of memory region definitions held in the elements of the memory region definitions register, wherein the transition to execution of the routine comprises steps of:
initially executing the routine in the first context;
the routine disabling memory region definitions in the first set of memory region definitions held in the elements of the memory region definitions register other than at least one excepted definition, wherein the at least one excepted definition comprises one or more memory region definitions required for execution of the routine;
the routine switching from the first set of access attributes to a temporary set of all-cacheable access attributes;
the routine storing a copy of the one or more memory region definitions required for execution of the routine held in one or more enabled elements of the memory region definitions register into one or more spare elements of the memory region definitions register that are disabled;
atomically switching execution of the routine to a temporary context using a temporary memory map by the routine enabling the copy of the one or more memory region definitions required for execution of the routine held in the one or more spare elements of the memory region definitions register and the routine disabling the one or more memory region definitions required for execution of the routine held in the one or more enabled elements of the memory region definitions register;
the routine setting up the second memory map by storing the second set of memory region definitions in one or more predetermined elements of the memory region definitions register; and
atomically switching execution of the routine to the second context using the second memory map by the routine enabling the second set of memory region definitions in the one or more predetermined elements of the memory region definitions register and the routine disabling the copies of the memory region definitions required for execution of the routine held in the spare elements of the memory region definitions register.

2. The method of claim 1, wherein the transition to execution of the routine in the second context further comprises a step of switching from the temporary set of all-cacheable access attributes to a second set of access attributes which are to be used for further execution of the routine in the second context following the transition.

3. The method of claim 2, wherein the second set of memory region definitions held in the elements of the memory region definitions register comprises at least one temporary storage memory region, and the second set of access attributes defines the temporary storage memory region as non-cacheable.

4. The method of claim 1, wherein the one or more spare elements of the memory region definitions register are selected from a predetermined double set of candidate elements of the memory region definitions register, wherein the predetermined double set of candidate elements has twice the number of elements as the one or more spare elements of the memory region definitions register.

5. The method of claim 1, wherein the initially executing the routine in the first context comprises the routine saving the first context and the routine determining from the first memory map the one or more memory region definitions required for execution of the routine.

6. The method of claim 5, wherein the routine determining from the first memory map the one or more memory region definitions required for execution of the routine comprises the routine determining from operands of a function call that called the routine memory addresses defining a memory region used for the routine.

7. The method of claim 5, wherein the one or more memory region definitions required for execution of the routine is a subset of the first set of memory region definitions.

8. The method of claim 1, further comprising, when performing the first data processing operations in the first context, prior to calling the routine, calling a diagnostic function to cause the data processing apparatus to operate in a diagnostic mode,
wherein the at least one excepted definition comprises at least one further memory region definition required for operating in the diagnostic mode held in at least one further element of the memory region definitions register.

9. The method of claim 8, wherein the at least one further memory region definition required for operating in the diagnostic mode defines a memory region allocated to a peripheral device,
wherein the memory region allocated to the peripheral device is non-cacheable,
and wherein the routine switching from the first set of access attributes to the temporary set of all-cacheable access attributes excludes the memory region allocated to the peripheral device.

10. The method of claim 9, wherein the data processing apparatus is configured to communicate with the peripheral device using universal asynchronous receiver/transmitter protocol (UART).

11. The method of claim 1, wherein the data processing apparatus comprises a memory region enable register, wherein respective elements of the memory region enable register correspond to respective elements of the memory region definitions register, and wherein a bit value held in each of the respective elements of the memory region enable register determines whether respective memory region definitions held in the elements of the memory region definitions register are enabled or not,
wherein atomically switching execution of the routine to the temporary context comprises writing the elements of the memory region enable register,
and wherein atomically switching execution of the routine to the second context comprises writing the elements of the memory region enable register.

12. The method of claim 1, wherein the data processing apparatus comprises a memory region attribute register, wherein elements of the memory region attribute register correspond to respective elements of the memory region definitions register, and wherein content of the elements of the memory region attribute register defines the set of access attributes associated with the set of memory region definitions.

13. The method of claim 12, wherein the data processing apparatus comprises a memory attribute indirection register, wherein elements of the memory attribute indirection register hold sets of access attributes, and wherein the elements of the memory region attribute register comprise element indicators referring to the elements of the memory attribute indirection register.

14. The method of claim 13, wherein the routine switching from the first set of access attributes to the temporary set of all-cacheable access attributes comprises performing a write to the elements of the memory attribute indirection register to set all-cacheable access attributes.

15. The method of claim 14, when dependent on claim 9, wherein performing the write to the elements of the memory attribute indirection register comprises masking at least one element in the memory attribute indirection register referred to by at least one element indicators of the memory region attribute register associated with the peripheral device.

16. The method of claim 1, wherein performing the first data processing operations in the first context comprises the data processing apparatus operating in a privileged mode, and wherein in transitioning to execution of the routine in the second context the data processing apparatus remains in the privileged mode.

17. A computer program which, when executed on a computer, causes the computer to:
perform data processing operations comprising accesses to memory, wherein the accesses to memory are delimited by a memory map defined by a set of memory region definitions held in elements of a memory region definitions register, and wherein the accesses are controlled by a set of access attributes associated with the set of memory region definitions;
perform first data processing operations in a first context, wherein the first context uses a first memory map defined by a first set of memory region definitions held in the elements of the memory region definitions register, and wherein the accesses to the memory are controlled by a first set of access attributes; and
during the first data processing operations call a routine and initiate a transition to execution of the routine in a second context, wherein the second context uses a second memory map defined by a second set of memory region definitions held in the elements of the memory region definitions register, wherein the transition to execution of the routine comprises steps of:
initially executing the routine in the first context;
the routine disabling memory region definitions in the first set of memory region definitions held in the elements of the memory region definitions register other than at least one excepted definition, wherein the at least one excepted definition comprises one or more memory region definitions required for execution of the routine;
the routine switching from the first set of access attributes to a temporary set of all-cacheable access attributes;
the routine storing a copy of the one or more memory region definitions required for execution of the routine held in one or more enabled elements of the memory region definitions register into one or more spare elements of the memory region definitions register that are disabled;
atomically switching execution of the routine to a temporary context using a temporary memory map by the routine enabling the copy of the one or more memory region definitions required for execution of the routine held in the one or more spare elements of the memory region definitions register and the routine disabling the one or more memory region definitions required for execution of the routine held in the one or more enabled elements of the memory region definitions register;
the routine setting up the second memory map by storing the second set of memory region definitions in one or more predetermined elements of the memory region definitions register; and
atomically switching execution of the routine to the second context using the second memory map by the routine enabling the second set of memory region definitions in the one or more predetermined elements of the memory region definitions register and the routine disabling the copies of the memory region definitions required for execution of the routine held in the spare elements of the memory region definitions register.

18. A computer-readable storage medium to store the computer program of claim 17.

19. A data processing apparatus comprising:
data processing circuitry configured to perform data processing operations, wherein the data processing circuitry has access to a memory region definitions register, wherein the data processing circuitry is configured to:
perform the data processing operations comprising accesses to memory, wherein the accesses to memory are delimited by a memory map defined by a set of memory region definitions held in elements of the memory region definitions register, and wherein the accesses are controlled by a set of access attributes associated with the set of memory region definitions;
perform first data processing operations in a first context, wherein the first context uses a first memory map defined by a first set of memory region definitions held in the elements of the memory region definitions register, and wherein the accesses to the memory are controlled by a first set of access attributes; and
during the first data processing operations calling a routine and initiating a transition to execution of the routine in a second context, wherein the second context uses a second memory map defined by a second set of memory region definitions held in the elements of the memory region definitions register, wherein for the transition to execution of the routine the data processing apparatus is configured such that:
the routine is initially executed in the first context;
the routine disables memory region definitions in the first set of memory region definitions held in the elements of the memory region definitions register other than at least one excepted definition, wherein the at least one excepted definition comprises one or more memory region definitions required for execution of the routine;
the routine switches from the first set of access attributes to a temporary set of all-cacheable access attributes;
the routine stores a copy of the one or more memory region definitions required for execution of the routine held in one or more enabled elements of the memory region definitions register into one or more spare elements of the memory region definitions register that are disabled;
execution of the routine is atomically switched to a temporary context using a temporary memory map by the routine enabling the copy of the one or more memory region definitions required for execution of the routine held in the one or more spare elements of the memory region definitions register and the routine disabling the one or more memory region definitions required for execution of the routine held in the one or more enabled elements of the memory region definitions register;
the routine sets up the second memory map by storing the second set of memory region definitions in one or more predetermined elements of the memory region definitions register; and
execution of the routine is atomically switched to the second context using the second memory map by the routine enabling the second set of memory region definitions in the one or more predetermined elements of the memory region definitions register and the routine disabling the copies of the memory region definitions required for execution of the routine held in the spare elements of the memory region definitions register.
